(19) United States
(12) Patent Application Publication
(10) Pub. No.: US 2007/0106022 A1
(43) Pub. Date: May 10, 2007

(54) Thermoplastic molding compositions

(75) Inventors: Martin Weber, Maikammer (DE); Axel Gottschelk, Neustadt (DE); Werner Haensel, Lingenfeld (DE); Walter Heckmann, Weinheim (DE); Hans Honl, Obersulzen (DE); Jurgen Deininger, Oftersheim (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 10/595,337

(22) PCT Filed: Oct. 8, 2004
(86) PCT No.: PCT/EP04/11255

§ 371 Date: Apr. 10, 2006

(30) Foreign Application Priority Data
Oct. 10, 2003 (DE) 103 47 870.1
Dec. 22, 2003 (DE) 103 61 152.5

(51) Int. Cl. C08L 77/00

(52) U.S. Cl. 525/66

(57) ABSTRACT

Thermoplastic molding compositions, comprising A) a polyamide A1), containing at least one end group derived from a piperidine compound, and B) a copolymer which contains at least one functional group which can react with the end groups of the polyamide present in component A).

The present invention relates to thermoplastic molding compositions which comprise

A) a polyamide A1), containing at least one end group derived from a piperidine compound of the formula (I) 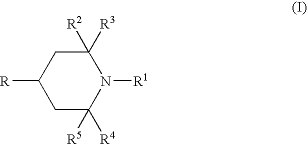
where
R is an amide-forming group R⁷ or a functional group R⁸ which bears from 14 identical or different amide-forming groups R⁷,
R¹ is H, C₁-C₂₀-alkyl, cycloalkyl, benzyl, or OR⁶, where
R⁶ is H, C₁-C₂₀-alkyl, cycloalkyl, or benzyl,
R², R³, R⁴ and R⁵, independently of one another, are C₁-C₁₀-alkyl, where R¹, R², R³, R⁴ and R⁵ may be different or identical, and
R⁷ has been selected from the group consisting of —(NHR⁹), where R⁹ is H, alkyl having from 1 to 8 carbon atoms, cycloalkyl having from 3 to 10 carbon atoms, or alkylene having from 2 to 20 carbon atoms, carboxy, and carboxylic acid derivatives, and
B) a copolymer, selected from
B1) a rubber-free random copolymer, containing, as monomeric units,
   b11) a styrene monomer,
   b12) a monomer which contains a functional group which can react with the end groups of the polyamide present in component A), and
   b13) components derived from a monomer which contains no functional groups which react with the end groups of the polyamide present in component A),
B2) a block copolymer of Y—X structure, containing
   B21) from 95 to 99.5% by weight of block Y, containing, as monomeric units,
   b21) a mixture composed of
   b211) a styrene monomer, and
   b212) a comonomer other than maleic anhydride, or
   b22) an ethylenically unsaturated ester
   and
   B22) from 0.5 to 5% by weight of block X, composed of a styrene monomer and of a copolymerizable anhydride, or of a copolymerizable acid, or of a mixture of these, as monomeric units, where the block X has, in essence, a strictly alternating structure;
      where the entirety of the components B21) and B22) is 100%, and
B3) a rubber-free, random copolymer, containing, as monomeric units
   b31) methyl methacrylate,
   b32) a copolymerizable anhydride, or a copolymerizable acid, or a mixture of these, and
   b33) also methacrylic esters or acrylic esters, or a mixture of these.

The present invention also relates to a process for preparing these molding compositions. The present invention further relates to the use, as color stabilizer for rubber-modified molding compositions, of polyamides which contain end groups which derive from piperidine compounds. This invention likewise encompasses moldings, foils, fibers, or foams which are obtainable from these molding compositions. Further embodiments of the present invention are found in the claims, in the description, and in the examples.

DE-A 100 096 47 has disclosed mixtures based on polyarylene ethers and on polyamides, where these have end groups which derive from piperidine compounds. These mixtures may comprise rubbers, and among these are functionalized rubbers, core-shell graft rubbers, and also thermoplastic polyester elastomers. The moldings produced from the mixtures have good ultimate tensile strength, can withstand high temperatures over a long period, and are dimensionally stable at increased temperatures. Although the blends disclosed in DE-A 100 096 47 have good flowability, their flowability level, which is in the range from about 14 to 42 [ml/10 min] at 300° C. under a load of 10 kg, is insufficiently high for many applications, in particular in the injection molding sector, where short cycle times are demanded.

Mixtures which comprise rubbers and polyamides, and also comprise a component which improves the compatibility of these two phases are known to the person skilled in the art. For example, EP-A 202 214, EP-A 784 080, and patent specification EP-B1 946 644 disclose impact-resistant blends which comprise ABS-type rubbers. DE-A 100 24 935 discloses weathering-resistant mixtures which comprise graft rubbers, the graft base of which may be a silicone rubber, EP(D)M rubber, or acrylate rubber. The intrinsic color of the known compositions is unsatisfactory.

It is an object of the present invention to provide, in the polyamide blend sector, thermoplastic molding compositions which combine good technical properties, such as heat resistance, flowability, and impact strength, even at low temperatures, and which moreover have improved colorfastness. A further object was to develop molding compositions which require minimum addition of UV stabilizers as additive, the intention being firstly to make the preparation of the molding compositions more cost-effective, and secondly to eliminate problems which can result, for example, from the escape of these additives. A further object of the present invention was to find molding compositions of the type mentioned which can be processed to give moldings which in essence have no flow lines or at least only have a very reduced level of flow lines (also termed “tiger lines” or shear marks). At the same time, the molding composition should be capable of processing to give moldings whose surfaces are scratch-resistant. We have found that this object is achieved by the thermoplastic molding compositions mentioned at the outset.

Component A

According to the invention, the thermoplastic molding compositions comprise a polyamide A1). For the purposes of the present invention, this means that a mixture composed of two or more different polyamides A1) may also be used. By way of example, use may be made of polyamides A1) having a different underlying structure but having the same end group. However, it is also possible to use polyamides A1) having the same underlying structure and end groups which derive from different piperidine compounds. It is also possible to use mixtures composed of polyamides A1) which contain different contents of end groups which derive from the piperidine compounds.

According to the invention, use is made of a polyamide A1) among whose end groups there is at least one which derives from a piperidine compound of the formula (I).

For the purposes of the present invention, polyamides are homopolymeric or copolymeric, synthetic long-chain polyamides in which repeating amide groups are a substantive constituent of the main polymer chain. Examples of these polyamides are nylon-6 (polycaprolactam), nylon-6,6 (polyhexamethyleneadipamide), nylon-4,6 (polytetramethyleneadipamide), nylon-6,10 (polyhexamethylenesebacamide), nylon-7 (polyenantholactam), nylon-11 (polyundecanolactam), nylon-12 (polydodecanolactam). As is known, these polyamides have the generic name nylon.

There are in principle two processes for preparing polyamides.

Polymerization starting from dicarboxylic acids and from diamines, as with polymerization starting from amino acids, reacts the amino and carboxy end groups of the starting monomers or starting oligomers with one another to form an amide group and water. The water can then be removed from the polymeric material. The polymerization starting from carboxamides reacts the amino and amide end groups of the starting monomers or starting oligomers with one another to form an amide group and ammonia. The ammonia can then be removed from the polymeric material.

Examples of suitable starting monomers or starting oligomers for preparing polyamides are

(1) C₂-C₂₀, preferably C₃-C₁₈, amino acids, such as 6-aminocaproic acid, 11-aminoundecanoic acid, and also dimers, trimers, tetramers, pentamers and hexamers thereof,

(2) amides of C₂-C₂₀ amino acids, for example 6-aminocaproamide, 11-aminoundecanamide, and also dimers, trimers, tetramers, pentamers and hexamers of these,

(3) products of the reaction of
(3a) C₂-C₂₀, preferably C₂-C₁₂, alkylenediamines, such as tetramethylenediamine or preferably hexamethylenediamine, with
(3b) a C₂-C₂₀, preferably C₂-C₁₄, aliphatic dicarboxylic acid, such as sebacic acid, decanedicarboxylic acid or adipic acid, and also dimers, trimers, tetramers, pentamers and hexamers of these reaction products,

(4) products of the reaction of (3a)
with
(4b) a C₈-C₂₀, preferably C₈-C₁₂, aromatic dicarboxylic acid or derivatives thereof, for example chlorides, e.g. 2,6-naphthalenedicarboxylic acid, preferably isophthalic acid or terephthalic acid,
and also dimers, trimers, tetramers, pentamers and hexamers of these reaction products,

(5) products of the reaction of (3a)
with
(5b) a C₉-C₂₀, preferably C₉-C₁₈, arylaliphatic dicarboxylic acid or derivatives thereof, for example chlorides, e.g. o-, m- or p-phenylenediacetic acid,
and also dimers, trimers, tetramers, pentamers and hexamers of these reaction products,

(6) products of the reaction of
(6a) C₆-C₂₀, preferably C₆-C₁₀, aromatic diamines, such as m- or p-phenylenediamine, with (3b),
and also dimers, trimers, tetramers, pentamers and hexamers of these reaction products,

(7) products of the reaction of
(7a) C₇-C₂₀, preferably C₈-C₁₈, arylaliphatic diamines, such as m- or p-xylylenediamine, with (3b),
and also dimers, trimers, tetramers, pentamers and hexamers of these reaction products, and

(8) monomers or oligomers of a C₂-C₂₀, preferably C₂-C₁₈, arylaliphatic or preferably aliphatic lactam, such as enantholactam, undecanolactam, dodecanolactam or caprolactam,

and also homopolymers or copolymers or mixtures of these starting monomers or starting oligomers.

Preference is given here to those starting monomers or starting oligomers which during the polymerization give the polyamides nylon-6, nylon-6,6, nylon-4,6, nylon-6, 10, nylon-7, nylon-11, or nylon-12, in particular nylon-6 or nylon-66.

R in the compound of the formula (I) is an amide-forming group R⁷ or a functional group which bears from 1-4 identical or different amide-forming groups R⁷.

Amide-forming groups R⁷ which may be used are —(NHR⁹), where R⁹ is H or alkyl having from 1 to 8 carbon atoms, or cycloalkyl having from 3 to 10 carbon atoms or alkylene having from 2 to 20 carbon atoms, and —(NH)— is a preferred amide-forming group R⁷. R⁷ is in particular —NH₂.

R⁷ may also be carboxy or a carboxy-derivative group. For example, R⁷ may be —C(O)—X, where X has been selected from the group consisting of —OH, C₁-C₃₀-alkoxy, C₆-C₂₀-aryloxy, —NHR¹², where R¹² may be hydrogen, C₁-C₃₀-alkyl or C₆-C₂₀-aryl, and —NR¹³R¹⁴, where R¹³ and R¹⁴ may be identical or different and may be C₁-C₃₀-alkyl or C₆-C₂₀-aryl, and —OCOR¹⁵, where R¹⁵ may be C₁-C₃₀-alkyl or C₆-C₂₀-aryl. X is particularly preferably —OH. If X is an anhydride —OC(O)R¹⁵, R¹⁵ may also be a piperidine radical, so that the result is a symmetrical anhydride.

Radicals which may be used as R are C₁-C₂₀, preferably C₆-C₁₈, aromatic, preferably aliphatic unsaturated, with preference saturated, hydrocarbon radicals R⁸ which bear from 1-4 amide-forming groups R⁷. If R⁸ bears two or more groups R⁷, these groups may be different or preferably identical.

The hydrocarbon radicals R⁸ may bear functional groups such as ether groups, non-amide-forming amine groups, or acid groups, such as phosphonic acid groups, phosphoric acid groups, preferably sulfonic acid groups, or derivatives thereof, preferably salts, in particular alkali metal salts, such as lithium salts, sodium salts or potassium salts.

In one preferred embodiment, R⁸ is C₁-C₂₀-alkylene, in particular hexamethylene, having no functional groups other than R⁷.

Radicals which may be used as R¹ are alkyl having from 1 to 20 carbon atoms, preferably from 1 to 18 carbon atoms, substituted or preferably unsubstituted benzyl, or OR⁶, where R⁶ is alkyl having from 1 to 20 carbon atoms, preferably from 1 to 18 carbon atoms, substituted or preferably unsubstituted benzyl, or preferably hydrogen. A particularly preferred radical R¹ is H.

Suitable radicals R², R³, R⁴ and R⁵ are, independently of one another, alkyl having from 1 to 10 carbon atoms, preferably methyl or ethyl, in particular methyl. R², R³, R⁴ and R⁵ may be different, or preferably identical.

The piperidine derivatives linked to R may be identical or different, preferably identical.

The compound (I) used may be a chemical compound or a mixture of various compounds.

A particularly preferred compound of the formula (I) is 4-amino-2,2,6,6-tetramethylpiperidinohexane. This compound and its preparation are well known and the compound is available commercially, for example via Aldrich Chemical Company, Inc. Another particularly preferred compound of the formula I is 4-carboxy-2,2,6,6-tetramethylpiperidine.

The amount of piperidine compound to be used depends on its structure and reactivity, and also on the desired content of end groups which derive from the piperidine compounds. The amounts used are generally in the range from 0.01 to 2% by weight, preferably from 0.08 to 1.5% by weight, based on the total amount of polyamide-forming monomers.

The preparation of the polyamides A1) is known per se or can take place by processes known per se. For example, the starting monomers may be polymerized or polycondensed in the presence of the piperidine compounds (I) under conventional process conditions, the reaction taking place continuously or batchwise. However, it is also possible for the piperidine compounds (I) to be combined with a chain regulator as usually used for preparing polyamides. Examples of suitable processes can be found in WO 95/28443, WO 99/41297 or DE-A 198 12 135. The compound of the formula (I) is bonded to the polyamide by reaction of at least one of the amide-forming groups R⁷.

Due to steric hindrance, the secondary amino groups of the piperidine ring systems do not react here.

The inventive molding compositions may also comprise, as component A), a mixture composed of one, or of two or more different, polyamides A1) with one, or two or more different, polyamides A2). According to the invention, the polyamides A2) have no end groups which derive from a piperidine compound. What has been said above in relation to the polyamides A1) also applies to the underlying structure and the preparation of the polyamides A2). The following polyamides are particularly preferably used as polyamides A2):

Nylon-6, nylon-6,6, nylon-4,6, nylon-4,10, nylon-7, nylon-11, or nylon-12, or a mixture composed of two or more of these polyamides.

Nylon-6 is particularly preferably used as polyamide A2).

The end groups of the polyamide A2) are preferably amino end groups or carboxy end groups, or a mixture of these. It is possible for the polyamides A2) used here to comprise those which contain an excess of amino end groups, or else those which contain an excess of carboxy end groups. The polyamides A2) preferred are those which have an excess of carboxy end groups.

Depending on application sector, the proportions of the polyamides A1) and A2) may vary within wide ranges. Among the preferred mixtures are mixtures which comprise from 5 to 100% by weight of polyamides A1) and from 0 to 95% by weight of polyamides A2), based on the total weight of component A). Particular preference is given to mixtures which comprise from 50 to 100% by weight of polyamides A1) and from 0 to 50% by weight of polyamides A2), based on the total weight of component A). If polyamides A2) are present, their proportion in the mixture composed of A1) and A2) is mostly from 5 to 45% by weight, the mixture composed of A1) and A2) representing 100% by weight in total.

The proportion of component A) in the inventive molding compositions may vary within a wide range. Preferred inventive molding compositions comprise amounts of from 5 to 95% by weight, in particular from 10 to 90% by weight, of component A), based on the total weight of the molding composition. Particularly preferred molding compositions comprise from 12 to 88% by weight of component A), based on the total weight of the molding composition.

Component B)

The inventive molding compositions comprise a selected copolymer which contains at least one functional group which can react with the end groups of the polyamides present in component A). Component B) may, of course, also be a mixture of two or more different polymers. The copolymers B) have been selected from the copolymers B1) to B3). For the purposes of the present invention, this also means that component B) may also be a mixture composed of two, or all, of the copolymers B1) to B3).

Component B) may be a rubber-free copolymer B1). For the purposes of the present invention, this also means that component B1) may encompass any mixture composed of two or more of these copolymers. According to the invention, the copolymers B1) contain the units b11) to b13) with random distribution.

The structure of the copolymers B1) may be varied within wide limits, and is primarily such as to permit the nature and amount of the functional groups to be such as to allow a reaction with the end groups of the polyamides present in component A). It is moreover intended that the copolymer B1) have at least some, and in particular high, miscibility with component C), which is optionally present in the inventive molding compositions. The structure of the copolymer B1) is preferably composed of at least 30% by weight, based on the total weight of all of the units present in B1, of units b11) which derive from styrene monomers.

In one of the preferred embodiments, the copolymers B1) are based on a styrene monomer b11), and contain, as monomeric units b12), dicarboxylic anhydrides b121) or dicarboximides b122), or a mixture composed of b121) and b122), and units b13) which derive from other monomers which contain no groups which react with the end groups of the polyamides present in component A). For the purposes of the present invention, these include those which react, but only at a much lower rate.

In this embodiment, the proportion of the monomeric units b11) is preferably from 50 to 85% by weight, in particular from 60 to 80% by weight. The copolymers B1) very particularly preferably contain, as monomeric units, from 65 to 78% by weight of styrene monomers. All of the % by weight data are based on the total weight of b11) to b13).

The proportion of the units b121) which derive from a,o-unsaturated dicarboxylic anhydrides is preferably from 0.3 to 25% by weight. Copolymers B1) having substantially less than 0.3% by weight of the monomeric units b121), for example those having less than 0.1% by weight, are generally insufficiently reactive. Those having substantially more than 25% by weight mostly lose their good processing properties, because they have excessive crosslinking effect. The copolymers B1) preferably contain from 0.5 to 15% by weight, in particular from 0.7 to 10% by weight, very particularly preferably from 0.8 to 5% by weight, of b121), for example from 1 to 3% by weight of b121). All of the % by weight data are based on the total weight of the units b11) to b13).

In addition to the monomeric units b121), units b122) which derive from α,β-unsaturated, in particular cyclic, dicarboximides may be present in the copolymers B1), generally at from 0 to 40% by weight. Preferred copolymers B1) contain from 0 to 30% by weight of b122), in particular from 0 to 25% by weight, the % by weight data always being based on the total weight of the units b11) to b13).

The copolymers B1) may moreover also contain from 14.7 to 40% by weight, preferably from 19.5 to 35% by weight, in particular from 21.3 to 33% by weight, of units b13), based on the total weight of the units b11) to b13), where these derive from other compounds capable of free-radical polymerization.

Styrene monomers b11) which may be used comprise styrene and styrene derivatives. Among the suitable styrene derivatives are α-methylstyrene, or styrene derivatives substituted on the aromatic ring, for example C₁-C₈-alkyl-substituted styrenes, such as m-methylstyrene, p-methylstyrene, tert-butylstyrene, or chlorostyrene. It is, of course, also possible to use a mixture of different styrene monomers. The use of styrene alone is very particularly preferable.

Among the preferred α,β-unsaturated dicarboxylic anhydrides b121) are cyclic compounds, and specifically those having from 2 to 20 carbon atoms. The double bond may be either exocyclic or endocyclic. Among these compounds, particular preference is given to maleic anhydride, methylmaleic anhydride, or itaconic anhydride. It is likewise possible to use mixtures of different dicarboxylic anhydrides. The use of maleic anhydride alone is very particularly preferred.

The α,β-unsaturated dicarboximides b122) generally correspond to the abovementioned dicarboxylic anhydrides. The substituent on the nitrogen atom is generally a C₁-C₂₀-alkyl, C₄-C₂₀-cycloalkyl, C₁-C₁₀-alkyl-C₆-C₁₈-aryl, or C₆-C₁₈-aryl radical.

The alkyl radicals may be either linear or branched, and have interruption by one or more oxygen atoms, the oxygen atoms not being directly bonded to the nitrogen atoms, nor directly bonded to another oxygen atom. Among these alkyl radicals are methyl, ethyl, n-propyl, isopropyl, n-butyl, isobutyl, tert-butyl, n-hexyl, n-decyl, and n-dodecyl. The cycloalkyl radicals may be either unsubstituted or substituted. Examples of suitable substituents are alkyl groups, such as methyl or ethyl. Examples which may be mentioned of cycloalkyl radicals are cyclobutyl, cyclopentyl, cyclohexyl, and p-methylcyclohexyl. The alkyl group of the alkylaryl radicals may be either linear or branched, and the alkylaryl radicals may also have substituents. Examples of these substituents are alkyl groups, such as methyl or ethyl, or else halogen atoms, such as chlorine or bromine. Examples of alkylaryl radicals which may be used are benzyl, ethylphenyl, or p-chlorobenzyl. The aryl radicals may likewise be substituted or unsubstituted, examples of suitable substituents being alkyl groups, such as methyl or ethyl, or halogen atoms, such as chlorine or bromine. Among the preferred aryl radicals are phenyl and naphthyl. Very particularly preferred radicals are cyclohexyl or phenyl.

By way of example of units b13), mention may be made here of acrylic acid and acrylic acid derivatives, such as methacrylic acid, alkyl acrylates, such as ethyl acrylate, methyl methacrylate, ethyl methacrylate, or cyclohexyl methacrylate, or unsaturated nitriles, such as acrylonitrile or methacrylonitrile. Use may likewise be made of mixtures of these monomers. The use of acrylonitrile alone is very particularly preferred. By way of example of preferred copolymers B1) of this embodiment, mention is made of copolymers which have the following composition:

b11) from 50 to 85% by weight, preferably from 60 to 81 % by weight, of styrene,

b12) from 0.5 to 10% by weight, preferably from 1 to 5% by weight, of maleic anhydride, and

b13) from 14.5 to 40% by weight, preferably from 18 to 35% by weight, of acrylonitrile,

where the proportions of b11) to b13) give a total of 100% by weight.

The copolymers B1) generally have molar masses M_{W} (weight-average) of from 30 000 to 500 000 g/mol, preferably from 50 000 to 250 000 g/mol, in particular from 70 000 to 200 000 g/mol, determined by means of GPC, using tetrahydrofuran (THF) as eluent and polystyrene calibration.

By way of example, the copolymers B1) of this embodiment may be prepared by free-radical polymerization of the corresponding monomers. This reaction may take place either in suspension or emulsion or else in solution or bulk, preference being given to the latter option. The free-radical reaction may generally be initiated using the usual methods, for example using light, or preferably using free-radical initiators, such as peroxides, e.g. benzoyl peroxide. Thermally initiated polymerization is also possible.

In another possible method of preparing the copolymers B1) of this embodiment, the monomeric units b11), b121), and, where appropriate, b13) are first reacted with one another in a free-radical reaction, and then some of the anhydride groups present in the reaction product are converted into imide groups, using appropriate primary amines or ammonia, thus producing the units b122). This reaction is generally carried out in the presence of a tertiary amine as catalyst, at temperatures of from 80 to 350° C.

In another preferred embodiment, the copolymers B1) contain, instead of the units b121) or b122) or a mixture of these, units b123) which derive from an unsaturated monomer which contains an epoxy group. The units b123) may also be based on a mixture composed of two or more different monomers of this type. The monomers may have one or else two or more epoxy groups. The use of glycidyl methacrylate alone is particularly preferred.

Among the preferred copolymers B1) of this embodiment are copolymers containing:

b11) from 65 to 85% by weight, preferably from 70 to 80% by weight, of styrene,

b123) from 0.5 to 10% by weight, preferably from 1 to 5% by weight, of glycidyl methacrylate, and

b13) from 14.5 to 34.5% by weight, preferably from 19 to 29% by weight, of acrylonitrile,

where the proportions of b11) to b13) give a total of 100% by weight.

By way of example, the copolymers B1) of this embodiment may be prepared by suspension polymerization, using, by way of example, polyvinyl alcohol as protective colloid, in the presence of a peroxidic initiator.

The copolymers B1) of this embodiment generally have molar masses (weight-average Mw) in the range from 50 000 to 1 000 000 g/mol, preferably from 70 000 to 500 000 g/mol, determined by GPC, using THF as eluent, against a polystyrene standard.

Component B) may also be composed of one or more different block copolymers B2). According to the invention, the block copolymers B2) have a two-block structure (Y—X structure). For the purposes of the present invention, this definition also covers those block copolymers which have a block Y whose free end groups may have been capped using monomers of which the block X is composed. This means that they may have been capped using a styrene monomer and/or an anhydride or an acid. However, for the purposes of the present invention, the structure of the block copolymers B2) is not intended to have three or more blocks. The block copolymers B2) are particularly preferably linear.

The block copolymers B2) may have a broad, or a narrow, molecular weight distribution. One measure of the breadth of the molecular weight distribution is the polydispersity index. This is defined as
PDI=weight-average molecular weight Mw/number-average molecular weight Mn

(where Mw and Mn must, of course, have been measured using the same method of determination, the nature of the method of determination being, however, as desired). Among the preferred block copolymers B2) of this invention are block copolymers with a polydispersity index in the range from 1.1 to 5, in particular from 1.2 to 4. Preference is given to block copolymers B2) whose molar mass (Mw) is in the range from 15 000 to 500 000 g/mol, in particular in the range from 20 000 to 300 000 g/mol. The molecular weight is determined here by means of gel permeation chromatography (GPC) on the basis of a polystyrene standard, using tetrahydrofuran as eluent.

The proportion of the block Y is preferably from 95 to 99.5% by weight of the block copolymers, preferably from 96 to 99% by weight, and that of the block X is preferably from 0.5 to 5% by weight, with preference from 1 to 4% by weight.

According to the invention, the block Y contains, as monomeric units, a mixture b21). The mixture b21) is composed of at least one styrene monomer b211) and of at least one comonomer b212) which is not maleic anhydride. Preference is given to mixtures b21) composed of from 60 to 90% by weight, particularly preferably from 65 to 85% by weight, in particular from 70 to 82% by weight, of component b211) and of from 10 to 40% by weight, particularly preferably from 15 to 35% by weight, in particular from 18 to 30% by weight, of component b212), where the entirety of components b211) and b212) gives a total of 100%.

Styrene monomers b211) which may be used are those mentioned for b11). The use of styrene alone is particularly preferred.

The component b212) may derive from one, or from a mixture of two or more, different, copolymerizable monomer(s). Among the suitable comonomers are in particular:

unsaturated nitriles, such as acrylonitrile or methacrylonitrile;

aliphatic esters, such as C₁-C₄-alkyl esters of methacrylic or acrylic acid, e.g. methyl methacrylate, and also the glycidyl esters, glycidyl acrylate and glycidyl methacrylate; N-substituted maleimides, such as N-methyl-, N-phenyl-, and N-cyclohexylmaleimide; acids, such as acrylic acid, methacrylic acid; and dicarboxylic acids, such as maleic acid, fumaric acid, and itaconic acid;

nitrogen-functional monomers, such as dimethylaminoethyl acrylate, diethylaminoethyl acrylate, vinylimidazole, vinylpyrrolidone, vinylcaprolactam, vinylcarbazole, vinylaniline, acrylamide, and methacrylamide;

aromatic and araliphatic esters of (meth)acrylic acid, such as phenyl acrylate, phenyl methacrylate, benzyl acrylate, benzyl methacrylate, 2-phenylethyl acrylate, 2-phenylethyl methacrylate, 2-phenoxyethyl acrylate, and 2-phenoxyethyl methacrylate;

unsaturated ethers, such as vinyl methyl ether or vinyl butyl ether.

Preferred comonomers b212) used are acrylonftrile, C₁-C₄-alkyl esters of methacrylic or acrylic acid, and also N-substituted maleimides, or a mixture of these. Among the particularly preferred comonomers b212) are acrylonitrile, methyl methacrylate, methyl acrylate, and N-phenylmaleimide. In one of the preferred embodiments, these abovementioned comonomers may be used individually. In another preferred embodiment, a mixture composed of two of the abovementioned monomers, e.g. acrylonitrile with methyl methacrylate, or of three or all of the abovementioned comonomers may be used. It is particularly preferable to use acrylonitrile or methyl methacrylate alone. Use of acrylonitrile alone is particularly preferred.

Instead of this, the block Y may contain, as monomeric units b22), at least one, e.g. one, or a mixture composed of two or more different, ethylenically unsaturated ester(s). Among the esters suitable as component b22) are the aliphatic, aromatic, and also araliphatic esters listed above for b211). The monomeric units b22) used preferably comprise C₁-C₄-alkyl esters of methacrylic or acrylic acid, or a mixture of these. Use of methyl methacrylate is particularly preferred.

In one preferred embodiment, the block Y contains a mixture b21) as monomeric units.

According to the invention, the block X is composed of styrene monomers and maleic anhydride, or of another copolymerizable anhydride, or of a copolymerizable acid, or of a mixture of these, as monomeric units. Styrene monomers which may be used are those mentioned for b11). Examples of a copolymerizable acid or copolymerizable anhydride which may be used are maleic acid, itaconic acid, Kaconic anhydride, fumaric acid, or glutaric anhydride.

Very particular preference is given to the use of styrene and maleic anhydride. These are preferably in essence strictly alternating. For the purposes of the present invention, this means that each styrene radical is generally followed by a maleic anhydride radical, but there is no intention here to exclude completely the possibility that two or more, e.g. two or three, radicals of the same type may follow one another. However, for the purposes of the present invention, this does not mean that block formation takes place within the block X itself. For each styrene radical in block X, therefore, there is generally one maleic anhydride radical present. However, there may be a slight excess of one of the radicals over the other radical, and therefore specifically in the case of short block lengths there does not necessarily need to be equimolarity in the strict sense. It is particularly preferable for the block X to have a purely and strictly alternating structure.

The molar mass (weight-average Mw) of block X is generally smaller than that of block Y. The molar mass (weight-average Mw) of block X is preferably smaller than 5000 g/mol, with preference smaller than 1500 g/mol, in particular smaller than 1000 g/mol, determined by GPC measurement, using tetrahydrofuran as eluent and polystyrene calibration.

In one of the particularly preferred embodiments, the inventive block copolymers B2) contain a block Y composed of styrene and acrylonitrile whose molar mass (weight-average Mw) is in the range from 80 000 to 200 000 g/mol, and a block X composed of styrene and maleic anhydride whose molar mass (weight-average Mw) is in the range from 500 to 1500 g/mol.

The block copolymers B2) may be prepared by suitable methods, e.g. by means of free-radical polymerization. Controlled free-radical polymerization is preferably used to prepare the block copolymers B2). Methods for carrying out controlled free-radical polymerization are known to the person skilled in the art, e.g. from DE-A 19917675, DE-A 19939031, and DE-A 19858103. The block copolymers B2) may be prepared in bulk, or by means of solution, suspension, microsuspension, emulsion, or miniemulsion polymerization. The process may take place continuously or batchwise. The apparatus used for the polymerization depends on the polymerization process used. Depending on the polymerization process, other suitable additives may be added, examples being emulsifiers of protective colloids. These additives are described individually by way of example in DE-A 19917675. The block copolymers B2) may also be prepared in a combined process in which two of the abovementioned polymerization methods are combined with one another. Mention may be made here in particular of bulk/solution, bulk/suspension, and bulk/emulsion, the first-mentioned being used at the start and the last-mentioned being used at the conclusion. The block copolymers B2) are preferably prepared in bulk, and continuously. Preferred additives during the preparation of the block copolymers B2) are ethylbenzene, toluene, or other solvents, these permitting control of viscosity.

The selection of the initiator, and the manner of its addition, depends firstly on the nature of the polymerization process and secondly on the nature of the monomers to be polymerized. 2,2′-azobisisobutyronitrile (AIBN) is particularly preferably used as initiator for preparing the block copolymers B2). Further amounts of the initiator(s) may, by way of example, be added directly prior to the start of the polymerization, or else continuously during the course of the polymerization. In the case of preparation of the block copolymers B2) in a batch process, the initiator preferably either forms an initial charge or, in particular, is added entirely at the start of the polymerization. In the case of a continuous procedure, the preferred method of initiator feed, if desired in the presence of a molecular weight regulator, is continuous, or staged, or takes the form of a feed profile. The amount of initiator is usually from 0.05 to 2% by weight, preferably from 0.07 to 1% by weight, based on the amount of monomers to be polymerized.

Various methods may be used for the controlled free-radical polymerization of the block copolymers B2). Each method used uses a different system for controlled free-radical polymerization, these being known per se to the person skilled in the art and being described by way of example in further detail in DE-A 199 17 675. By way of example, the method used may be that known as atom transfer radical polymerization (ATRP) or a related method. It is also possible to use triazolinyl compounds for controlled reinitiation during controlled free-radical polymerization. Another method for controlled free-radical polymerization is catalytic chain transfer (CTT). Controlled free-radical polymerization may also be carried out by means of reversible addition fragmentation chain transfer (RAFT). Another method which can be used for controlled free-radical polymerization of the block copolymers B2) is initiator-transfer-termination (iniferter).

The stable free-radical polymerization method (SFRP) is particularly preferred for preparing the block copolymers B2). This polymerization takes place in the presence of stable free radicals, and the equilibrium between growing polymer chain end and inactive species is utilized to control the polymerization reaction.

Particularly stable free radicals used are stable N-oxyl radicals, and in principle it is possible to use any of the stable N-oxyl radicals.

Examples of suitable stable N-oxyl radicals derived from a secondary amine are those of the formula (II)

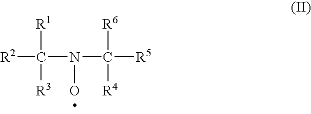

where

R¹,R²,R⁵ and R⁶ are identical or different straight- or branched-chain, unsubstituted or substituted alkyl groups, cycloalkyl groups, aralkyl groups, or aryl groups, and

R³ and R⁴ are identical or different straight- or branched-chain, unsubstituted or substituted alkyl groups, or

R³CNCR⁴ is a portion of a cyclic structure which has, where appropriate, another fused saturated or aromatic ring, where the cyclic structure or the aromatic ring may, where appropriate, have substitution.

Mention may be made by way of example of the following representatives of stable

N-oxyl radicals suitable according to the invention:

2,2,6,6-tetramethyl-1-oxylpiperidine (TEMPO),

4-oxo-2,2,6,6-tetramethyl-1-oxylpiperidine (4-oxoTEMPO),

2,2,5,5-tetramethyl-1-oxylpyrrolidine,

3-carboxy-2,2,5,5-tetramethyl-1-oxylpyrrolidine,

2,6-diphenyl-2,6-dimethyl-1-oxylpiperidine,

4-hydroxy-2,2,6,6-tetramethyl-1-oxylpiperidine (4-hydroxyTEMPO),

2,5-diphenyl-2,5-dimethyl-1-oxylpyrrolidine, and

di-tert-butyl nitroxide.

The following N-oxyl radicals are particularly preferably used:

Tempo, 4-oxo-Tempo, or 4-hydroxy-Tempo.

According to the invention it is, of course, also possible to use mixtures of stable N-oxyl radicals.

Depending on its solubility behavior, the stable N-oxyl radical may be added either undiluted or dissolved in organic solvents, such as alcohols, e.g. methanol and/or ethanol, or else ethyl acetate and/or dimethylformamide. For the purposes of the inventive process, the molar ratio between stable N-oxyl radicals and free-radical polymerization initiator is normally from 0.5:1 to 5:1, preferably from 0.8:1 to 4:1. It is particularly preferable for the ratio to be 1.5:1 for preparing the inventive block copolymers B2).

The block copolymers B2) are usually prepared at an absolute pressure in the range from atmospheric pressure to 60 bar, preferably up to 45 bar, and at a temperature of from 70 to 170° C., preferably from 80 to 150° C. It is particularly preferable to prepare the block copolymers B2) at a pressure in the range from atmospheric pressure to 5 bar and at a temperature in the range from 60 to 120° C.

Component B) may moreover be a, or a mixture composed of two or more different, rubber-free copolymer(s) B3). The copolymers B3) contain their components b31) to b33) with random distribution.

According to the invention, methyl methacrylate is used as monomeric units b31). Components b32) which may be used comprise those which derive from a copolymerizable anhydride or from a copolymerizable acid, or from a mixture of these. Those mentioned above for B22) are suitable. The use of maleic anhydride alone is particularly preferred. Component B3) may optionally also contain components b33) which derive from an ester of acrylic or methacrylic acid. Use may be made here of aromatic, aliphatic or cycloaliphatic esters. It is, of course, also possible to use a mixture composed of two or more different esters. Examples of suitable esters of methacrylic acid are ethyl methacrylate, butyl methacrylate, hexyl methacrylate, or cyclohexyl methacrylate. By way of example of esters of acrylic acid, mention may be made of: methacrylate, ethyl acrylate, butyl acrylate, hexyl acrylate, or cyclohexyl acrylate.

The composition of component B3) may vary within wide limits, but it is preferable for the components b31) which derive from methyl methacrylate to predominate, e.g. to represent more than 60% by weight. In one of the preferred embodiments, component B3) contains from 70 to 99.9% by weight of monomeric units b31), from 0.1 to 5% by weight of monomeric units b32), and from 0 to 25% by weight of units b33), based on the total weight of component B3). Particularly preferred components B3) are copolymers which contain from 70 to 99.9% by weight of methyl methacrylate, from 0.1 to 5% by weight of maleic anhydride, and from 0 to 25% by weight of an ester of acrylic or methacrylic acid, based on the total weight of component B3).

Component B3) may be prepared by the methods known per se to the person skilled in the art. Component B3) is preferably obtained via bulk polymerization of the monomers in the presence of free-radical initiators and of molecular weight regulators, at temperatures below 80° C. The conversion is preferably at least 95%, in particular at least 98%. Details concerning the preparation of component B3) may be found, by way of example, in the patent specification EP-B1 946 644. The molar mass (weight-average) of component B3) is preferably in the range from 10 000 to 500 000 g/mol, particularly preferably in the range from 30 000 to 250 000 g/mol.

The proportion of component B) in the inventive molding compositions may vary within a wide range. Preferred inventive molding compositions comprise amounts of from 5 to 95% by weight, in particular from 10 to 90% by weight, of component B), based on the total weight of the molding composition. Particularly preferred molding compositions comprise from 12 to 88% by weight of component B), based on the total weight of the molding composition.

Component C)

In the inventive molding compositions, a further component C) may be present, encompassing a graft copolymer C1). For the purposes of the present invention, this means that the material to be encompassed is either one graft copolymer C1) or else a mixture composed of two or more different graft copolymers C1). In one of the preferred embodiments, use is made of one graft copolymer C1) alone. In another preferred embodiment, use is made of a mixture composed of two graft copolymers C1) whose rubber content differs from one another by at least 5% by weight, or in other words whose proportions of graft base c11) differ from one another by at least 5% by weight. Component C) may comprise one, or a mixture composed of two or more different, matrix polymer(s) C2) alongside the graft copolymers C1).

In another preferred embodiment, it is possible for a matrix polymer C2), or a mixture composed of two or more different matrix polymers, to be used as component C).

The graft copolymer C1) contains a rubber as graft base c11). In principle, suitable materials here are any of the rubbers which have a glass transition temperature of 0° C. (determined to DIN 53765) or below. The rubbers may be of very different types. By way of example, use may be made of silicone rubbers, olefin rubbers, such as ethylene rubbers, propylene rubbers, ethylene-propylene rubbers, EP(D)M rubbers, block rubbers, such as styrene-ethylene-butadiene-styrene (SEBS) rubbers, diene rubbers, acrylate rubbers, ethylene-vinyl acetate rubbers, or ethylene-butyl acrylate rubbers, or a mixture composed of two or more of these rubbers.

Preferred silicone rubbers contain, as organic radicals, at least 80 mol % of methyl groups. The end group is generally a diorganylhydroxysiloxy unit, preferably a dimethylhydroxysiloxy unit. Crosslinked silicone rubbers are particularly used as graft base c1). By way of example, these may be prepared by a first stage in which silane monomers, such as dimethyldichlorosilane, vinylmethyidichloromethane, or dichlorosilanes having other substituents, are reacted to give cyclic oligomers. In a further stage, crosslinked silicone rubbers may be obtained by ring-opening polymerization of the cyclic oligomers with addition of crosslinking agents, such as mercaptopropylmethyidimethoxysilane. The diameter of the silicone rubber particles (ponderal median d₅₀) is preferably from 0.09 to 1 μm, with preference from 0.09 to 0.4 μm (determined as in W. Scholtan and H. Lange, Kolloid-Z. und Z.-Polymere 250 (1972), pp 782-796, by means of an ultracentrifuge).

The EP(D)M rubbers suitable as graft base c11) are co- or terpolymers which contain at least one ethylene unit and one propylene unit, and preferably a small number of double bonds, i.e. fewer than 20 double bonds per 1000 carbon atoms. The terpolymers generally contain at least 30% by weight of units which derive from ethylene and at least 30% by weight of units which derive from propylene, based on the total weight of the terpolymer. Other units present in the terpolymers generally comprise diolefins having at least five carbon atoms. Processes for their preparation are known per se. The diameters of the EP(D)M rubber particles (ponderal median d₅₀) are generally in the range from 0.05 to 10 μm, preferably from 0.1 to 5 μm, in particular from 0.15 to 3 μm (determined as stated above by means of an ultracentrifuge).

Acrylate rubbers which may be used are in particular polymers composed of alkyl acrylates, where these may contain up to 40% by weight of other copolymerizable monomers, based on the total weight of the acrylate rubber. Preference is given to C₁-C₈-alkyl esters, e.g. methyl esters, ethyl esters, butyl esters, n-octyl esters, and 2-ethylhexyl esters, or a mixture of the esters mentioned. Crosslinked acrylate rubbers are particularly preferably used as graft base c11). Processes for their preparation are familiar to the person skilled in the art. The diameters of their particles are generally in the range of those mentioned for the EP(D)M rubbers.

Acrylate rubbers and diene rubbers are preferred as graft base c11). Among the preferred mixtures which may be used as graft base c11) are mixtures composed of diene rubber and acrylate rubber, or composed of diene rubber and silicone rubber, or composed of diene rubber and rubber based on ethylene copolymers.

However, particular preference is given to diene rubbers alone as c11). Very particular preference is given to diene rubbers which are composed of

γ11) from 50 to 100% by weight of at least one diene having conjugated double bonds, and

γ12) from 0 to 50% by weight of one or more other monoethylenically unsaturated monomers,

the percentages by weight of γ11) and γ12) giving a total of 100.

The dienes which may be used and have conjugated double bonds, γ11), may in particular comprise butadiene, isoprene, and halogen-substituted derivatives of these, such as chloroprene. Preference is given to butadiene or isoprene, in particular butadiene.

Examples of the other monoethylenically unsaturated monomers γ12) which may be present with concomitant reduction in the amounts of the monomers γ11) in the diene rubber are:

vinylaromatic monomers, preferably styrene or styrene derivatives, such as C₁-C₈-alkyl-substituted styrenes, e.g. c-methylstyrene, p-methylstyrene, vinyltoluene; unsaturated nitriles, such as acrylonitrile or methacrylonitrile; aliphatic esters, such as C₁-C₄-alkyl esters of methacrylic or acrylic acid, e.g. methyl methacrylate, and also the glycidyl esters, glycidyl acrylate and glycidyl methacrylate;

N-substituted maleimides, such as N-methyl-, N-phenyl-, and N-cyclohexylmaleimide; acids, such as acrylic acid, methacrylic acid; and dicarboxylic acids, such as maleic acid, fumaric acid, and itaconic acid, and also their anhydrides, such as maleic anhydride; nitrogen-functional monomers, such as dimethylaminoethyl acrylate, diethylaminoethyl acrylate, vinylimidazole, vinylpyrrolidone, vinylcaprolactam, vinylcarbazole, vinylaniline, acrylamide, and methacrylamide;

aromatic and araliphatic esters of (meth)acrylic acid, such as phenyl acrylate, phenyl methacrylate, benzyl acrylate, benzyl methacrylate, 2-phenylethyl acrylate, 2-phenylethyl methacrylate, 2-phenoxyethyl acrylate, and 2-phenoxyethyl methacrylate; unsaturated ethers, such as vinyl methyl ether or vinyl butyl ether.

It is, of course, also possible to use a mixture composed of two or more of these monomers.

Preferred monomers γ12) are styrene, acrylonitrile, methyl methacrylate, glycidyl acrylate, glycidyl methacrylate, or butyl acrylate.

The preparation of the rubbers is known to the person skilled in the art, or may be carried out using methods known to the person skilled in the art. By way of example, the diene rubbers may be prepared by a first step in which they are not produced in particle form, examples of methods here being solution polymerization or gas-phase polymerization, the polymers then being dispersed in the aqueous phase in a second step (secondary emulsification). For the preparation of the rubbers, preference is given to heterogeneous polymerization processes which form particles. This dispersion polymerization may be conducted, by way of example, in a manner known per se by the emulsion polymerization, inverse emulsion polymerization, miniemulsion polymerization, microemulsion polymerization, or microsuspension polymerization method, using a feed process, continuously, or using a batch process. The rubbers may also be prepared in the presence of a fine-particle latex which forms an initial charge (known as the “seed latex” polymerization method). By way of example, suitable seed latices are composed of polybutadiene or polystyrene. In principle, it is possible to use the rubbers as graft base after their preparation. However, prior to the grafting they may also first be agglomerated through agglomeration processes to give larger particles.

Agglomeration processes are known to the person skilled in the art. Methods known per se to the person skilled in the art may also be used to undertake the agglomeration process. For example, use may be made of physical methods, such as freeze agglomeration or pressure agglomeration processes. However, it is also possible to use chemical methods to agglomerate the primary particles. Among the latter is the addition of inorganic or organic acids. The agglomeration is preferably undertaken by means of an agglomeration polymer in the absence or presence of an electrolyte, such as an inorganic hydroxide. By way of example, agglomeration polymers which may be mentioned are polyethylene oxide polymers or polyvinyl alcohols. Among suitable agglomeration polymers are copolymers of C₁-C₁₂-alkyl acrylates or of C₁-C₁₂-methalkyl acrylates and of polar comonomers, such as acrylamide, methacrylamide, ethacrylamide, n-butylacrylamide, or maleamide.

The rubbers preferably have particle sizes (ponderal median d₅₀) in the range from 100 to 2500 nm. The particle size distribution is preferably almost or completely monomodal, or almost or completely bimodal.

The graft copolymers C1) contain a graft c12) based on an unsaturated monomer, and this means that the graft may also have been prepared from two or more unsaturated monomers. In principle, a very wide variety of unsaturated compounds may be used for grafting to the rubber. Appropriate compounds and methods are known per se to the person skilled in the art. Preference is given to a graft c12) containing

γ21) from 50 to 100% by weight, preferably from 60 to 100% by weight, and particularly preferably from 65 to 100% by weight, of a vinylaromatic monomer,

γ22) from 0 to 50% by weight, preferably from 0 to 40% by weight, and particularly preferably from 0 to 35% by weight, of acrylonitrile or methacrylonitrile or a mixture of these,

γ23) from 0 to 40% by weight, preferably from 0 to 30% by weight, and particularly preferably from 0 to 20% by weight, of one or more other monoethylenically unsaturated monomers,

where the proportions of components γ21) to γ23) give a total of 100% by weight.

Vinylaromatic monomers which may be used are the vinylaromatic compounds as specified under δ12), or a mixture composed of two or more of these, in particular styrene or α-methylstyrene. Other monoethylenically unsaturated monomers are, as specified under δ12, the aliphatic, aromatic, and araliphatic esters, acids, nitrogen-functional monomers, and unsaturated ethers, and mixtures of these monomers.

However, the graft may also contain monomers having functional groups, and among these particular mention may be made of epoxy groups or oxazoline groups.

One or more steps of a process may be used to prepare the graft c12). The monomers here, γ21), γ22), and γ23), may be added individually or in a mixture with one another. The monomer ratio in the mixture may be constant over time or represent a gradient. Combinations of these procedures may also be used.

By way of example, the material polymerized onto the graft base c11) may first be styrene alone, and then a mixture of styrene and acrylonitrile.

By way of example, preferred grafts c12) are composed of styrene and/or of α-methyl-styrene, and of one or more of the other monomers mentioned under γ22) and γ23). Preference is given to methyl methacrylate, N-phenylmaleimide, maleic anhydride, and acrylonitrile, methyl methacrylate and acrylonitrile being particularly preferred.

Preferred grafts c12) derive from:

c12-1: styrene

c12-2: styrene and acrylonitrile,

c12-3: α-methylstyrene and acrylonitrile,

c12-4: styrene and methyl methacrylate.

The proportion of styrene or α-methylstyrene, or the proportion of the entirety of styrene and α-methylstyrene, is particularly preferably at least 40% by weight, based on c12).

Other suitable graft polymers are those with two or more “soft” and “hard” stages, especially if the particles are relatively large.

Preference is given to graft polymers C1) which (based on C1)) comprise

c11) from 30 to 95% by weight, preferably from 40 to 90% by weight, in particular from 40 to 85% by weight, of graft base (i.e. rubber), and

c12) from 5 to 70% by weight, preferably from 10 to 60% by weight, in particular from 15 to 60% by weight, of a graft.

By way of example of preferred graft polymers C1), mention may be made of those which contain (based on C1)),

c11) from 30 to 95% by weight of a graft base containing (based on c11))
from 50 to 90% by weight of butadiene and
from 10 to 50% by weight of styrene,

and

c12) from 5 to 70% by weight of a graft containing (based on c12))
from 65 to 85% by weight of styrene and
from 15 to 35% by weight of acrylonitrile.

By way of example, among preferred graft polymers C1) are also those which contain (based on C1)),

c11) from 30 to 95% by weight of a graft base containing n-butyl acrylate, and containing a crosslinking agent,

and

c12) from 5 to 70% by weight of a graft containing (based on c12))
from 65 to 85% by weight of styrene and
from 15 to 35% by weight of acrylonitrile.

The grafting is generally carried out in emulsion. Suitable process measures are known to the person skilled in the art. If ungrafted polymers composed of the monomers c12) are produced, these amounts, which are generally less than 10% by weight of C1), are counted with the weight of component C2).

Component C) preferably comprises a matrix polymer C2) alongside the graft copolymer C1), and for the purposes of the present invention the matrix polymer may also be a mixture composed of two or more different matrix polymers. The molecular structure of the matrix polymer C2) is preferably selected in such a way that the matrix polymer is compatible with the graft c12). The monomers c12) therefore preferably correspond to those of the matrix polymer C2). However, the matrix polymers contain no functional groups which can react with the end groups of the polyamides present in component A).

According to the invention, the matrix polymer C2) is rubber-free, and is a homo- or copolymer based on a styrene monomer or on a (meth)acrylic ester, comonomers which may be used comprising unsaturated nitriles, maleimide, and maleic anhydride, or a mixture of these. Suitable styrene monomers are those mentioned for b11). Among these, particular preference is given to styrene and α-methylstyrene. (Meth)acrylic esters which may be used comprise aliphatic esters, such as C₁-C₄-alkyl esters of methacrylic or acrylic acid. Examples of these esters have been mentioned for b33). Particular preference is given to the use of methyl methacrylate. By way of example, a polystyrene or a polymethyl methacrylate may be used as matrix polymer C2).

The matrix polymer C2) may also comprise SAN (styrene-acrylonitrile), AMSAN (α-methylstyrene-acrylonitrile), styrene-maleimide-maleic anhydride (SNPMIMA), styrene-maleic acid/anhydride-acrylonitrile polymers, or SMA (styrene-maleic anhydride).

Component C2) is preferably a copolymer composed of

c21) from 60 to 100% by weight, preferably from 65 to 80% by weight, of units of a styrene monomer, preferably of styrene, of a substituted styrene, or of a (meth)acrylic ester, in particular of styrene or of α-methylstyrene, or of a mixture of these, and

c22) from 0 to 40% by weight, preferably from 20 to 35% by weight, of units of an unsaturated nitrile, preferably of acrylonitrile or of methacrylonitrile, in particular of acrylonitrile.

In one embodiment of the invention, the matrix polymer here is composed of from 60 to 99% by weight of styrene monomers and of from 1 to 40% by weight of at least one of the stated comonomers.

In one embodiment of the invention, a copolymer of styrene and/or α-methylstyrene with acrylonitrile is used as C2). The acrylonitrile content in these copolymers is from 0 to 40% by weight, preferably from 20 to 35% by weight, based on the total weight of C2).

The molar masses (weight-average M,) are generally in the range from 50 000 to 500 000 g/mol, preferably in the range from 70 000 to 450 000 g/mol. The matrix polymers C2) are known per se, or may be prepared by methods known to the person skilled in the art.

The ratio C1):C2) of the components may vary within a wide range. For example, in one embodiment C1) may be used alone, and in another embodiment C2) may be used alone. In another embodiment, the molding compositions may comprise a mixture composed of C1) and C2), where, by way of example, C) comprises from 20 to 85% by weight, with preference from 25 to 80% by weight, of C1) and from 15 to 80% by weight, with preference from 20 to 75% by weight, of C2), where the proportions by weight of C1) and C2) give 100 in total.

The inventive molding compositions generally comprise from 0 to 60% by weight, based on the total weight of the molding composition, of component C. If component C is present, its amount is generally from 1 to 50% by weight, based on the total weight of the molding composition.

Component D

A low-molecular-weight may be used concomitantly as another component in the inventive molding compositions, this having only one dicarboxylic anhydride group. However, it is also possible to use two or more of these compounds as component D). These components may contain, besides the dicarboxylic anhydride group, other functional groups which can react with the end groups of the polyamides. Examples of suitable compounds D) are C₄-C₁₀-alkanedicarboxylic anhydrides, such as succinic anhydride, glutaric anhydride, adipic anhydride. Use may also be made of cycloaliphatic dicarboxylic anhydrides, such as 1,2-cyclohexanedicarboxylic anhydride. However, it is also possible to use dicarboxylic anhydrides which are ethylenically unsaturated or aromatic compounds, e.g. maleic anhydride, phthalic anhydride, or trimellitic anhydride.

The proportion of component D) is generally from 0 to 3% by weight, preferably from 0.001 to 2% by weight, based on the total weight of the molding compositions.

Component E

The molding compositions may comprise additives. Use may be made here of one additive or of a mixture composed of two or more different additives. Their proportion is generally from 0 to 60% by weight, preferably from 0 to 50% by weight, based on the total weight of the molding compositions.

Examples of the materials which may be used here are particulate mineral fillers. Suitable materials among these are amorphous silica, carbonates, such as magnesium carbonate, chalk, powdered quartz, mica, a very wide variety of silicates, such as clays, muscovite, biotite, suzoite, Un maletite, talc, chlorite, phlogopite, feldspar, calcium silicates, such as wollastonite, or kaolin, particularly calcined kaolin.

In one particularly preferred embodiment, use is made of particulate fillers in which at least 95% by weight, preferably at least 98% by weight, of the particles have a diameter (largest dimension), determined in the finished product, of less than 45 μm, preferably less than 40 μm, their aspect ratio preferably being in the range from 1 to 25, with preference in the range from 2 to 20, determined in the finished product, i.e. generally in an injection molding. An example of the method for determining these particle diameters records electron micrographs of thin sections of the polymer mixture and utilizes at least 25, preferably at least 50, filler particles for evaluation. The particle diameter may also be determined by sedimentation analysis, as in Transactions of ASAE, p. 491 (1983). The proportion of the fillers by weight which is less than 40 μm may also be measured by sieve analysis. The aspect ratio is the ratio of particle diameter to thickness (largest dimension to smallest dimension).

The particulate fillers used particularly preferably comprise talc, kaolin, such as calcined kaolin, or wollastonite, or a mixture of two or all of these fillers. Among these, particular preference is given to talc with a proportion of at least 95% by weight of particles whose diameter is smaller than 40 μm and whose aspect ratio is from 1.5 to 25, in each case determined in the finished product. Kaolin preferably has a proportion of at least 95% by weight of particles whose diameter is smaller than 20 μm and whose aspect ratio is from 1.2 to 20, determined in each case in the finished product. If the particulate fillers are present, their amounts used are in general from 0 to 30% by weight, based on components A) to E). If the particulate fillers are present, their amounts used are generally from 3 to 25% by weight.

The component E) used may also comprise fibrous fillers, such as natural fibers, carbon fibers, potassium titanate whiskers, aramid fibers, or preferably glass fibers, at least 50% by weight of the fibrous fillers (glass fibers) having a length of more than 50 μm. The (glass) fibers used may preferably have a diameter of up to 25 μm, particularly preferably from 5 to 13 μm. It is preferable for at least 70% by weight of the glass fibers to have a length of more than 60 μm. In the finished molding, the average length of the glass fibers is particularly preferably from 0.08 to 0.5 mm. The length of the glass fibers relates to a finished molding, for example one obtained by injection molding. The glass fibers added to the molding compositions may either be continuous-filament strands (rovings) or may previously have been converted to the appropriate length. If the fibrous fillers are present, their amounts used are in general from 0 to 50% by weight, based on components A) to E). If the fibrous fillers are present, their amounts used are generally from 5 to 40% by weight, based on A) to E).

Component E) may encompass other additives, such as phosphorus-containing flame retardants, processing aids, stabilizers, and oxidation retarders, peak stabilizers, lubricants, mold-release agents, and plasticizers. If these are present, then amounts used are in general from 0 to 25% by weight, based on components A) to E). If these are present, their amounts used are generally from 1 to 20% by weight, based on A) to E).

Dyes and pigments may likewise be present as component E) in the inventive molding compositions. By way of example, the proportion of these may be from 0 to 20% by weight, based on components A) to E). If these are present, their amounts present are in general from 0.001 to 15% by weight, based on A) to E).

Component E) may encompass UV stabilizers. However, the amount of UV stabilizers which is needed in order to achieve comparable colorfastness in molding compositions in which component A) is not present is generally relatively small. The amounts which may be present of the UV stabilizers are from 0 to 3% by weight, based on components A) to E). If these are present, their amounts present are in general from 0.1 to 2% by weight, based on A) to E).

It has been found that addition of stearates or silicone oil in amounts of from 0.3 to 1.5% by weight, based on the total weight of the molding compositions, can considerably reduce the formation of flow lines during processing. In addition, the moldings composed of the molding compositions which comprise these additives are particularly scratch-resistant. To this end, the amounts preferably added of the stearates or silicone oil are in the range from 0.3 to 1.3% by weight, in particular from 0.5 to 1% by weight, based on the total weight of the molding compositions. By way of example, use may be made here of salts of stearic acid, e.g. calcium stearate, zinc stearate, or aluminum stearate. It is also possible to use a mixture composed of two or more different salts of stearic acid. Silicone oils whose use is preferred are those which derive from linear polysiloxanes. Particular preference is given to silicone oils with linear polydimethylsiloxanes. Among the particularly preferred silicone oils are those whose viscosity is in the range from 20 to 100 000 mPas, preferably from 100 to 60 000 mPas (dynamic viscosity at 25° C.).

It is also possible to use a mixture composed of two or more different silicone oils. It is likewise possible to use mixtures composed of one, or a mixture of different, stearate(s) with one, or a mixture of different, silicone oil(s). By way of example, use may be made of a mixture composed of calcium stearate with polydimethylsiloxane. However, preference is given to the use of either one stearate or one silicone oil alone. Calcium stearate is the particularly preferred stearate used and polydimethylsiloxane is the particularly preferred silicone oil used. It has proven very particularly advantageous to use calcium stearate alone.

The stearate and, respectively, the silicone oil, or their mixtures, may be introduced into the molding compositions in a very wide variety of ways. By way of example, they may be fed separately or in a mixture. An example of a possible method here adds these additives together with the other components, or after addition of some of the other components, and mixes the additives with these. However, it is also possible, for example, to add these additives to the molding compositions only after the latter have been pelletized, and to apply the additives to the surface of the pellets. The application of the stearate and, respectively, the silicone oil can take place in the usual mixing apparatus, such as fluid mixers, turbine mixers, or Röhnrad mixers.

The inventive thermoplastic molding compositions may be prepared by methods known per se by mixing component A) with component B), and also, if they are present, with components C) to E). All of the components here may be simultaneously mixed with one another. However, it may also be advantageous to premix individual components. It is also possible, although less preferable, for the components to be mixed in solution, with removal of the solvents.

In one embodiment of the invention, it is preferable to premix component B) and a portion of component A) in the form of their pellets, and then to melt these together and convert them to a graft copolymer P). In principle, the pellets may be mixed with one another by a very wide variety of methods, for example manual methods, turbine mixer, fluid mixer, Rhönrad mixer. The pellets are particularly preferably mixed with one another at room temperature by means of a turbine mixer, and within a period of from 1 to 5 minutes.

Examples of melting assemblies which may be used are Maxwell mixers, Banbury mixers, kneaders, Buss co-kneaders, Farrell kneaders, or single-, twin-, or multiscrew extruders, such as ring extruders or planetary gear extruders.

In the case of the twin-screw extruders, use may be made of those with corotating screws, or with counter-rotating screws, particular preference being given to co-rotating, intermeshing screws. The corotating twin-screw extruders whose use is preferred generally have at least one feed section provided with forward-conveying screw elements, at least one homogenizing section provided with kneading and reverse-conveying elements, and at least one mixing section with forward-conveying, reverse-conveying, and kneading elements. It is also possible here to use specific mixing elements, such as toothed mixing elements, melt mixing elements, or turbine mixing elements. The extruders preferably comprise one feed section, one homogenization section, and one mixing section. The preferred extruders mostly also have one, two or more devolatilization sections. These particularly preferably follow the (last) mixing section. The devolatilization sections may be operated at atmospheric pressure, at superatmospheric pressure, or in vacuo. It is preferable for the devolatilization sections to be operated at atmospheric pressure or in vacuo. It is particularly preferable for the devolatilization sections to be operated under a vacuum of from 10 to 900 mbar, preferably from 20 to 800 mbar, in particular from 30 to 600 mbar. Following the devolatilization section(s), the preferred extruders generally have a metering section and a pelletizing unit. The latter may, for example, be a strand pelletizer, an underwater pelletizer, or a water-coled die-face pelletizer, preference being given to strand pelletizers and underwater pelletizers. The metering section may, of course, also instead be an injection-molding unit.

The temperature during the preparation of the graft copolymers P) by the melt process is generally in the range from 200 to 350° C., preferably in the range from 220 to 340° C.

If the entire amount of component B) is reacted with a portion of component A) to give the graft copolymers P), the amount of component A) here may vary within a wide range. However, the portion used of A) should be adjusted so that firstly an adequate amount of graft copolymer P) is formed and secondly there is no great excess of polyamide alongside the graft copolymer P). The graft copolymers P) may contain from 5 to 95% by weight, preferably from 10 to 90% by weight, of copolymers B) and from 5 to 95% by weight, preferably from 10 to 90% by weight, of polyamide. The amount of polyamide is particularly preferably adjusted so that the molar ratio of the functional groups of component B) to the end groups of the polyamide is from 0.8:1 to 1.3:1, preferably from 0.9:1 to 1.3:1.

The resultant graft copolymers P) may be mixed with the remaining amount of component A), and also with the other components, if they are present. Any of the known methods may be used to mix the components, for example the dry components. The mixing preferably takes place at temperatures of from 200 to 320° C. by extruding, kneading, or roll-milling of the components together, the components having been isolated previously, where appropriate, from the aqueous dispersion or from the solution obtained during the polymerization process.

The inventive thermoplastic molding compositions may be processed by the known methods of thermoplastics processing, for example by extrusion, injection molding, calendering, blowmolding, or sintering.

The inventive molding compositions may be used to produce foils, fibers, moldings, or foams. They may also particularly preferably be processed to produce vehicle-interior components.

In one of the preferred embodiments of the present invention, the polyamides A1) may be used as a color stabilizer for rubber-modifed thermoplastic molding compositions.

### EXAMPLES

Performance Tests:

The viscosity number of the polyamides was determined to DIN 53 727 on 0.5% strength by weight solutions in 96% strength by weight sulfuric acid at 23° C.

The viscosity number of the terpolymers was determined in dimethylformamide at 25° C. on 0.5% strength by weight solutions.

The particle size of the graft rubbers is the ponderal median d₅₀, determined as in W. Scholtan and H. Lange, Kolloid-Z. und Z.-Polymere 250 (1972), pp 782-796, by means of an analytical ultracentrifuge.

The heat resistance of the specimens was determined by means of the Vicat softening point. The Vicat softening point was determined to DIN 53 460, on standard small specimens, using a force of 49.05 N and a temperature rise of 50 K per hour.

The notched impact strength of the products was determined on ISO specimens to ISO 179 1 eA.

Flowability was determined to ISO 1133 at 240° C. with 5 kg load.

Melt viscosity was determined in a capillary rheometer at a temperature of 290° C. and a shear rate of 55 Hz. To characterize processing stability, the melt viscosity was determined after 5 and 25 minutes of residence time in the capillary rheometer under these conditions. The table gives the change during the residence time, based on the value measured at 5 minutes.

The color of the specimens was determined after aging of injection-molded plaques (60×60×2 mm) for a period of 1000 hours to DIN 75202-2a “high-temperature lighffastness” (Atlas Ci35, irradiation intensity 1.2 W/m² (420 nm), aging temperature 100° C.). Assessment was visual, in each case using three plaques. Class 1 means that no discoloration of the specimen had occurred. Class 5 means that the specimen had discolored to an intense yellow color.

To assess shear marks (flow lines), plaques of differing thickness and differing surface roughness are injection-molded (plaque 1: 350×120×1 mm, smooth surface; plaque 2: 210×175×2 mm, eroded surface). The surfaces are assessed visually on a scale from 1 to 5: 1 (poor, i.e. shear marks well developed and pronounced) 5 (good, i.e. shear marks invisible to the naked eye).

To determine scratch resistance, the surfaces of the plaques were treated with emery paper.

Surface quality was then assessed visually and classified on a scale from 1 (poor, i.e. pronounced evidence of grinding discernible) to 5 (good, i.e. in essence no evidence of grinding discernible with the naked eye).

Component A1₁

The polyamide A1₁ used was a nylon-6 obtained from ε-caprolactam, with a viscosity number of 146 mVg (measured at 0.5% strength by weight in 96% strength sulfuric acid) and having 0.15% by weight triacetonediamine content.

Component A2₁

The polyamide A2₁ used was a nylon-6 obtained from ε-caprolactam, with a viscosity number of 150 ml/g.

Component B1₁

The component B1₁ used was a styrene-acrylonitrilemaleic anhydride terpolymer whose composition was 74.5/24.5/1.0 (% by weight). Viscosity number 78 ml/g

Componente B1₂

The component B1₂ used was a styrene-acrylonitrile-maleic anhydride terpolymer, whose composition was 74123.512.5 (% by weight). Viscosity number 80 ml/g

Component B1₃

The component B1₃ used was a styrene-acrylonitrile-maleic anhydride terpolymer, whose composition was 73123.213.8 (% by weight). Viscosity number: 81 ml/g

Component B1₄

The component B1₄ used was a styrene-acrylonitrile-maleic anhydride terpolymer whose composition was 72.8122.7/4.5 (% by weight). Viscosity number: 82 ml/g

Component C1₁

Graft rubber having 62% by weight of polybutadiene in the core and 38% by weight of a graft shell composed of 75% by weight of styrene and 25% by weight of acrylonitrile. Particle size about 400 nm.

Component C1₂

Graft rubber having 70% by weight of polybutadiene in the core and 30% by weight of a graft shell composed of 75% by weight of styrene and 25% by weight of acrylonitrile. Particle size about 370 nm.

Component C1₃

Network-type rubber comprising a core-shell structure composed of crosslinked dimethylsiloxane with a glass transition temperature of −128° C. (8.3% by weight, based on the entire network-type rubber), an n-butyl acrylate rubber with a Tg of −45° C., and a graft shell, in essence composed of methyl methacrylate with a Tg of 90° C. Each of the glass transition temperatures was determined by means of a torsion pendulum at a frequency of 1 Hz and a heating rate of 10° C./min. The product used was Metablen® S 2001 from Metablen Company B.V., Vlissingen, Netherlands.

Component C2₁

Styrene-acrylonitrile copolymer comprising 75% by weight of styrene and 25% by weight of acrylonitrile, and having a viscosity number of 80 ml/g.

Component D₁

The component D₁ used was phthalic anhydride.

Component E₁

Chopped glass fiber with polyurethane size, fiber diameter 10 μm.

Component E₂

Calcium stearate (e.g. Ceasit® from Bärlocher).

Preparation of the molding compositions 1C to 10

The components were mixed in a twin-screw extruder at a melt temperature of from 240 to 260° C. The melt was passed through a waterbath and pelletized.

The test results are listed in table 1.

TABLE 1

| | Molding composition | | | | | | | | | |
|---|---|---|---|---|---|---|---|---|---|---|
| | 1C | 2 | 3 | 4 | 5 | 6 | 7 | 8 | 9C | 10 |
| A1₁ | — | 41 | 41 | 41 | 41 | 41 | 41 | 41 | — | 35 |
| A2₁ | 41 | — | — | — | — | — | — | — | 41 | — |
| B1₁ | — | — | — | 5 | — | — | — | — | 5 | — |
| B1₂ | 5 | 5 | 5 | — | — | — | — | — | — | 5 |
| B1₃ | — | — | — | — | 5 | 5 | — | — | — | |
| B1₄ | — | — | — | — | — | — | 5 | 5 | — | — |
| C1₁ | 34.8 | 34.8 | 35 | 35 | 35 | 34.8 | 35 | 35 | — | 25 |
| C1₂ | — | — | — | — | — | — | — | — | — | — |
| C1₃ | — | — | — | — | — | — | — | — | 35 | — |
| C2₁ | 19 | 19 | 19 | 19 | 19 | 19 | 19 | 19 | 19 | 15 |
| D₁ | 0.2 | 0.2 | — | — | — | 0.2 | — | 0.4 | — | — |
| E₁ | — | — | — | — | — | — | — | — | — | 20 |
| Vicat B [° C.] | 105 | 102 | 104 | 101 | 104 | 105 | 103 | 103 | 101 | 118 |
| MVI [ml/10′] | 5.2 | 16.2 | 10.9 | 11.4 | 10.3 | 11.2 | 9.6 | 11.4 | 8.6 | 7.4 |
| aₙ, RT [kJ/m²] | 51 | 23 | 66 | 24 | 61 | 64 | 21 | 54 | 24 | 12 |
| aₙ, −30° C. [kJ/m²] | 15 | 11 | 15 | 12 | 14 | 15 | 11 | 14 | 9 | 8 |
| MVI change [%] | −51 | −21 | −12 | −14 | −10 | −16 | −14 | −21 | −36 | −15 |
| Color | 4 | 2 | 2 | 2 | 2 | 2 | 2 | 2 | 1-2 | 2 |

Preparation of molding composition 11

The components were mixed in a twin-screw extruder at a melt temperature of from 240 to 260° C. The melt was passed through a water bath and pelletized.

The results of the tests are found in table 2.

TABLE 2

Molding composition [% by weight]

| Components | No. 3 | No. 11 | No. 12 | No. 13 |
|---|---|---|---|---|
| A1₁ | 41 | 41 | 41 | 40.5 |
| A2₁ | — | — | — | — |
| B1₂ | 5 | 5 | 5 | 5 |
| C1₁ | 35 | 34.8 | 30 | 29.6 |
| C1₂ | — | — | 5 | 4.9 |
| C2₁ | 19 | 18.1 | 19 | 19 |
| D1 | — | 0.1 | — | — |
| E2 | — | 1 | — | 1 |

Properties

| | | | | |
|---|---|---|---|---|
| MVI [ml/10′] | 10.9 | 9.7 | 11.6 | 11.4 |
| aₙ, RT [kJ/m²] | 66 | 57.2 | 67 | 65 |

Surface quality

| | | | | |
|---|---|---|---|---|
| Plaque 1 | 5 | 4.5 | 4.5 | 3.5 |
| Plaque 2 | 5 | 4.5 | 4.5 | 3.5 |

Scratch resistance

| | | | | |
|---|---|---|---|---|
| Plaque 1 | 3 | 2 | 3 | 1.5 |
| Plaque 2 | 3 | 1.5 | 3 | 1.5 |

1. A thermoplastic molding composition, comprising
A) a polyamide A1), containing at least one end group derived from a piperidine compound of the formula (I) 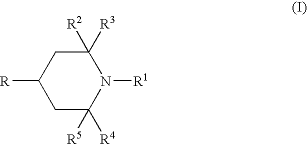
where
R is an amide-forming group R⁷ or a functional group R⁸ which bears from 1-4 identical or different amide-forming groups R⁷,
R¹ is H, C₁-C₂₀-alkyl, cycloalkyl, benzyl, or OR⁶, where
R⁶ is H, C₁-C₂₀-alkyl, cycloalkyl, or benzyl,
R²,R³,R⁴ and R⁵, independently of one another, are C₁-C₁₀-alkyl, where R¹, R², R³, R⁴ and R⁵ may be different or identical, and
R⁷ has been selected from the group consisting of —(NHR⁹), where R⁹ is H, alkyl having from 1 to 8 carbon atoms, cycloalkyl having from 3 to 10 carbon atoms, or alkylene having from 2 to 20 carbon atoms, carboxy, and carboxylic acid derivatives, and
B) a copolymer, selected from
B1) a rubber-free random copolymer, containing, as monomeric units,
b11) a styrene monomer,
b12) a monomer which contains a functional group which can react with the end groups of the polyamide present in component A), and
b13) a monomer which contains no functional groups which react with the end groups of the polyamide present in component A),
B2) a block copolymer of Y—X structure, containing
B21) from 95 to 99.5% by weight of block Y, containing, as monomeric units,
b21) a mixture composed of
b211) a styrene monomer, and
b212) a comonomer other than maleic anhydride, or
b22) an ethylenically unsaturated ester
and
B22) from 0.5 to 5% by weight of block X, composed of a styrene monomer and of a copolymerizable anhydride, or of a copolymerizable acid, or of a mixture of these, as monomeric units, where the block X has, in essence, a strictly alternating structure;
where the entirety of the components B21) and B22) is 100%, and
B3) a rubber-free, random copolymer, containing, as monomeric units
b31) methyl methacrylate,
b32) a copolymerizable anhydride, or a copolymerizable acid, or a mixture of these, and
b33) also, if desired, methacrylic esters or acrylic esters, or a mixture of these, and
c) a graft copolymer C1), containing a diene rubber as graft base c11) and a graft c12) based on an unsaturated monomer.

2. A thermoplastic molding composition as claimed in claim 1, where the polyamides A) have at least one end group derived from a piperidine compound, where R is a group of the formula —NH—R⁸—NH—, where R⁸ is an alkylene group having from 1 to 20 carbon atoms.

3. A thermoplastic molding composition as claimed in claim 1, where component A) is a mixture composed of polyamide A1) and of a polyamide A2) which contains no end groups which derive from a piperidine compound.

4. A thermoplastic molding composition as claimed in claim 1, where, as additional component, a rubber-free matrix polymer C2) is present, which in essence comprises, as monomeric units,
c21) a styrene monomer or a (meth)acrylic ester, and, if desired,
c22) an unsaturated nitrile, maleimide, or maleic anhydride, or a mixture of these.

5. A thermoplastic molding composition as claimed in claim 1, where component C) is a mixture composed of two graft copolymers C1) whose rubber contents differ from one another by at least 5% by weight.

6. A thermoplastic molding composition as claimed in claim 1, comprising from 0.3 to 1.5% by weight, based on the total weight of the molding composition, of a stearate or silicone oil, or a mixture of these.

7. A process for preparing thermoplastic molding compositions as claimed in claim 1, which comprises, in a first step, preparing a graft copolymer P) from a portion of component A) and the entire amount of component B), and, in a second step, mixing the graft copolymer P) with the other components and with the remaining amount of component A).

8. The use of the thermoplastic molding compositions as claimed in claim 1, for producing moldings, foils, fibers, or foams.

9. A molding, a foil, a fiber, or a foam, obtainable using thermoplastic molding compositions as claimed in claim 1.

10. A vehicle-interior component obtainable using moldings, foils, fibers, or foams as claimed in claim 9.

11. A thermoplastic molding composition as claimed in claim 2, where, as additional component, a rubber-free matrix polymer C2) is present, which in essence comprises, as monomeric units,
c21) a styrene monomer or a (meth)acrylic ester, and, if desired,
c22) an unsaturated nitrile, maleimide, or maleic anhydride, or a mixture of these.

12. A thermoplastic molding composition as claimed in claim 3, where, as additional component, a rubber-free matrix polymer C2) is present, which in essence comprises, as monomeric units,
c21) a styrene monomer or a (meth)acrylic ester, and, if desired,
c22) an unsaturated nitrile, maleimide, or maleic anhydride, or a mixture of these.

13. A thermoplastic molding composition as claimed in claim 2, where component C) is a mixture composed of two graft copolymers C1) whose rubber contents differ from one another by at least 5% by weight.

14. A thermoplastic molding composition as claimed in claim 3, where component C) is a mixture composed of two graft copolymers C1) whose rubber contents differ from one another by at least 5% by weight.

15. A thermoplastic molding composition as claimed in claim 4, where component C) is a mixture composed of two graft copolymers C1) whose rubber contents differ from one another by at least 5% by weight.

16. A thermoplastic molding composition as claimed in claim 2, comprising from 0.3 to 1.5% by weight, based on the total weight of the molding composition, of a stearate or silicone oil, or a mixture of these.

17. A thermoplastic molding composition as claimed in claim 3, comprising from 0.3 to 1.5% by weight, based on the total weight of the molding composition, of a stearate or silicone oil, or a mixture of these.

18. A thermoplastic molding composition as claimed in claim 4, comprising from 0.3 to 1.5% by weight, based on the total weight of the molding composition, of a stearate or silicone oil, or a mixture of these.

19. A thermoplastic molding composition as claimed in claim 5, comprising from 0.3 to 1.5% by weight, based on the total weight of the molding composition, of a stearate or silicone oil, or a mixture of these.

20. A thermoplastic molding composition as claimed in claim 2, where component A) is a mixture composed of polyamide A1) and of a polyamide A2) which contains no end groups which derive from a piperidine compound.
